(19) United States
(12) Patent Application Publication
(10) Pub. No.: US 2013/0295426 A1
(43) Pub. Date: Nov. 7, 2013

(54) BATTERY COMPARTMENT WITH COMMUNICATION INTERFACE AS WELL AS MEASUREMENT INSTRUMENT WITH THE BATTERY COMPARTMENT

(71) Applicants: Cafer Halavart, Schorndorf (DE); Florian Giesen, Dittelbrunn (DE)

(72) Inventors: Cafer Halavart, Schorndorf (DE); Florian Giesen, Dittelbrunn (DE)

(73) Assignee: Robert Bosch GmbH, Stuttgart (DE)

(21) Appl. No.: 13/825,569

(22) PCT Filed: Aug. 4, 2011
(86) PCT No.: PCT/EP2011/063466

§ 371 Date: Jul. 11, 2013

(30) Foreign Application Priority Data
Sep. 23, 2010 (DE) 10 2010 041 278.3

(51) Int. Cl. H01M 2/10

(52) U.S. Cl. CPC H01M 2/1022
USPC 429/99

(57) ABSTRACT

A battery compartment of an electrical appliance has at least one holder for an energy storage element, and at least one contact element configured to make electrical contact between the battery compartment and the appliance. An interface in the battery compartment is configured to communicate with an external application. An electrical appliance includes at least one such battery compartment.

The present invention relates to a battery compartment of an electrical appliance, in particular of a laser distance finder, with a holder for batteries as well as a cover element and a closure element.

### PRIOR ART

Battery-operated electrical appliances are known in different embodiments and can be embodied, in particular, as laser distance finders. The appliances usually have a battery compartment which is accommodated in an appliance housing and has holders into which the batteries can be inserted. The individual holders are assigned here electrical contacts via which the batteries are connected when they are inserted, and via which they are connected to the electronics of the appliance.

DE-199 14 541 A1 discloses a battery compartment which can be inserted into a laser spirit level and can also be removed as such from the appliance again. The battery compartment is constructed in the manner of a drawer, with the result that the batteries can first be placed in the battery compartment and the battery compartment then including the batteries is inserted into the appliance.

### DISCLOSURE OF THE INVENTION

The invention relates to a battery compartment of an electrical appliance, in particular of a hand-held distance finder. The battery compartment is embodied as a separate part which can be inserted in a modular fashion into the housing of the measuring instrument and connected thereto.

The battery compartment has at least one holder for at least one energy storage element such as, for example, a battery, a rechargeable battery or an accumulator element. Furthermore, the battery compartment has at least one electrical contact with which the battery compartment and, in particular, the energy storage element positioned in the battery compartment are connected to the electronics of the measuring instrument.

The battery compartment advantageously has an interface for communication with an external application.

An external application is understood here to be, in particular, an arrangement which is separate from the measuring instrument such as, for example, a separate PC (used as synonym for a computer here), a PDA (personal digital assistant), a cell phone, in particular an Internet-enabled “smartphone”, an external database or the like.

It is therefore advantageously possible to add this functionality to existing measuring instruments. As a result of the modular design of the battery compartment as a unit which can be disconnected from the housing of the measuring instrument, no changes, or only insignificant changes, have to be performed to the measuring instrument itself.

The interface for external communication, associated electronics and their connection to the measuring instrument therefore form a communication module which is arranged in the battery compartment of the electrical appliance and can, for example, also be exchanged for the latter.

The modular extension, integrated into the battery compartment, for communication, in particular for transmitting data, permits costs to be reduced for the measuring system since the inventive communication unit does not have to be integrated in all appliances of a series but rather, for example, can be delivered or retrofitted according to a customer's particular requirements.

The measuring instrument itself then only has to have a corresponding means, for example making mechanical contact, for transmitting data to the battery compartment according to the invention. The battery compartment according to the invention therefore has at least one contact element for transmitting data between the measuring instrument and battery compartment. This contact element is typically of mechanical design, but could also be wireless. For this reason, at least one further contact pin is advantageously provided in the battery compartment, via which pin the data transfer takes place between the measuring instrument and the battery compartment. However, it is in principle also possible to implement this data transfer via the contact elements which serve to supply energy to the measuring instrument.

A basic idea of the invention is therefore that both the batteries and the communication module are secured to the battery compartment insert, as a result of which when the battery compartment is removed they are also automatically removed from the housing. As a result, the batteries and communication module are easily accessible, and they can therefore be easily removed from the holder and inserted therein. In this context, the installation space of the battery compartment can advantageously be used to accommodate the components of the communication module.

Furthermore, the integration of the communication interface for the exchange of data with an external application provides an entire series of further advantages.

For example, when the basic appliance is acquired a user does not have to make a decision as to whether he would like to use communication standards in future, and which standards they are. In particular, it is also possible to change over from a first communication standard to a second, different communication standard, without exchanging the expensive measuring instrument per se.

In the basic appliance, the electrical appliance, for example a measuring instrument, there is no need to provide additional installation space for integrating the communication electronics or for providing a plug-in location for a separate communication module.

In the basic appliance, the electrical appliance, for example a measuring instrument, no additional costs are incurred for the supply of voltage to the communication unit since said unit is integrated directly in the battery compartment.

The module can advantageously be embodied in such a way that it is integrated completely in the housing of the measuring instrument in a positively locking fashion. The interface which is integrated into the battery compartment is advantageously designed here for wireless communication with the external application.

The interface can in this context be subject to one of the known communication standards such as, for example, Bluetooth or WLAN or USB or Firewire. However, in principle wire-bound communication, for example via an RS232 interface, is also possible.

The battery compartment according to the invention has at least one electronic unit, in particular an electronic unit for the communication electronics of the interface according to the invention. It is therefore possible, for example, to provide one circuit board or even two circuit boards for the communication electronics, for example with a Bluetooth chip and to integrate them into the battery compartment. The communication electronics advantageously receive their supply of energy from the energy storage elements of the battery compartment. The electronic unit of the battery compartment according to the invention is advantageously connected via a communication element, for example via an additional communication pin, to the electronics of the measuring instrument, in particular to the evaluation electronics of the measuring instrument, in order to implement the transfer of data between the measuring instrument and the battery compartment.

The battery compartment is advantageously embodied in the form of a drawer and has a holder as a carrier element for the energy storage elements. Furthermore, the battery compartment according to the invention has a cover element which closes off the measuring instrument housing when the battery compartment is inserted.

In many applications, electrical and electronic appliances have to operate reliably over many years under more difficult environmental conditions. Apart from the permissible temperature range, the chemical loading, this being understood to mean resistance to aggressive media in industry such as vapors, acids, lyes, oil or fuels, constitutes a restriction on use. In addition the penetration of wet and foreign bodies such as, for example, dust has to be prevented for reliable functioning to occur.

With respect to their suitability for various environmental conditions, the systems are classified into corresponding protection types, referred to as IP codes. The abbreviation IP stands, according to DIN, for International Protection, but it is also understood in English to mean Ingress Protection.

The battery compartment according to the invention is therefore also advantageously embodied as a battery compartment which is protected according to the “IP54 standard”.

For this purpose, the cover element of the battery compartment advantageously has, inter alia on its side facing the holder, sealing means, such as for example a sealing ring.

In this way, a measuring instrument, in particular a distance finder, can be provided with an additional communication module, and can ensure a battery-supported voltage supply and the corresponding IP protection without the basic appliance itself requiring the additional costs for the IP protection. The measuring instrument itself, which accommodates the battery compartment according to the invention, is therefore “burdened” neither with additional costs nor with other disadvantages such as for example the increase in the overall size. Since the entire electronics of the communication module are located in the IP-protected battery compartment, no additional measures are advantageously necessary for the electronic protection.

Further advantages of the battery compartment according to the invention and of a measuring instrument with such a battery compartment are apparent from the following drawings and the description of an exemplary embodiment.

### DRAWINGS

The drawings illustrate an exemplary embodiment of the invention. The drawings, the description and the claims contain numerous features in combination. A person skilled in the art will also expediently consider these features individually and combine them to form further appropriate combinations.

In the drawing:

FIG. 1 shows a front view of an electrical appliance according to the invention,

FIG. 2 shows a battery compartment with batteries of the electrical appliance shown in FIG. 1, in a perspective view,

FIG. 3 shows the battery compartment with batteries according to FIG. 2 in a rear view,

FIG. 4 shows a battery compartment without batteries and without the communication module according to the invention,

FIG. 5 shows a closure bolt for the battery compartment according to the invention in an enlarged illustration,

FIG. 6 shows a view of a detail of an electrical appliance with inserted battery compartment in a sectional illustration,

FIG. 7 shows a view of a detail from FIG. 1 clarifying the closure mechanism of the battery compartment according to the invention,

FIG. 8 shows a battery compartment without batteries and without the inventive communication module according to FIG. 4,

FIG. 9 shows an inventive battery compartment without batteries and with an additional contact element for the communication module according to the invention,

FIG. 10 shows the battery compartment according to the invention in a rear view,

FIG. 11 shows the battery compartment according to the invention with batteries inserted in a rear view, and

FIG. 12 shows the inventive battery compartment in a perspective view.

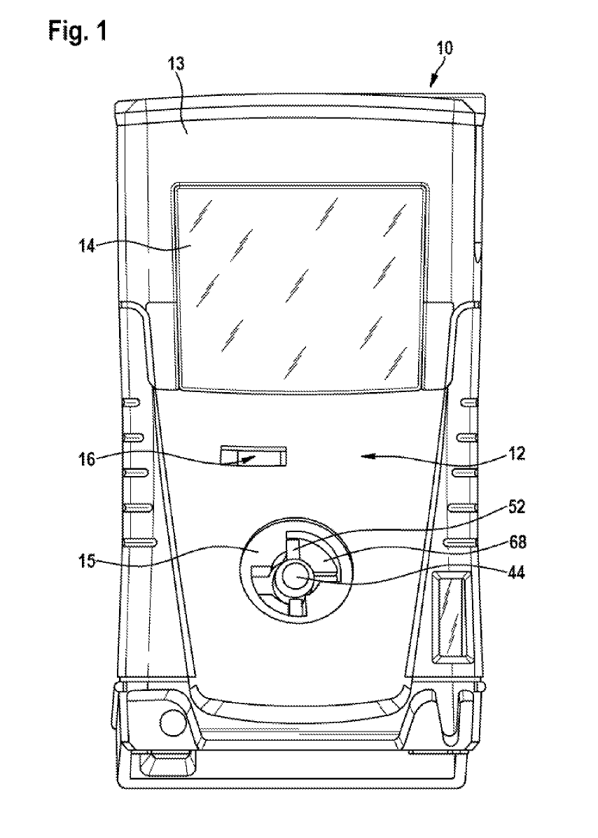

FIG. 1 of the drawing shows an electrical appliance according to the present invention, which is embodied in the present example as a laser distance finder. However, the electrical appliance according to the invention can also be any other appliance, but in particular a measuring instrument. The laser distance finder 10 comprises a housing 12 on whose upper side 13 a viewing window 14 of a display is arranged.

Furthermore, such an appliance typically also comprises a keypad 16 (illustrated only symbolically and not in more detail in FIG. 1) for activating the laser distance finder. The upper side 13 of the distance finder 10 is illustrated in sectional form in a region 15, in order to clarify the securing mechanism for the battery compartment according to the invention.

The method of functioning of such distance finders is known per se and will not be explained in more detail here.

Reference is merely made here to the relevant literature. The distance finder can be a laser distance finder, an ultrasound distance finder or a radar distance finder. For the subject matter of the invention, the type of the electrical appliance is of secondary importance. The electrical appliance is advantageously a measuring instrument.

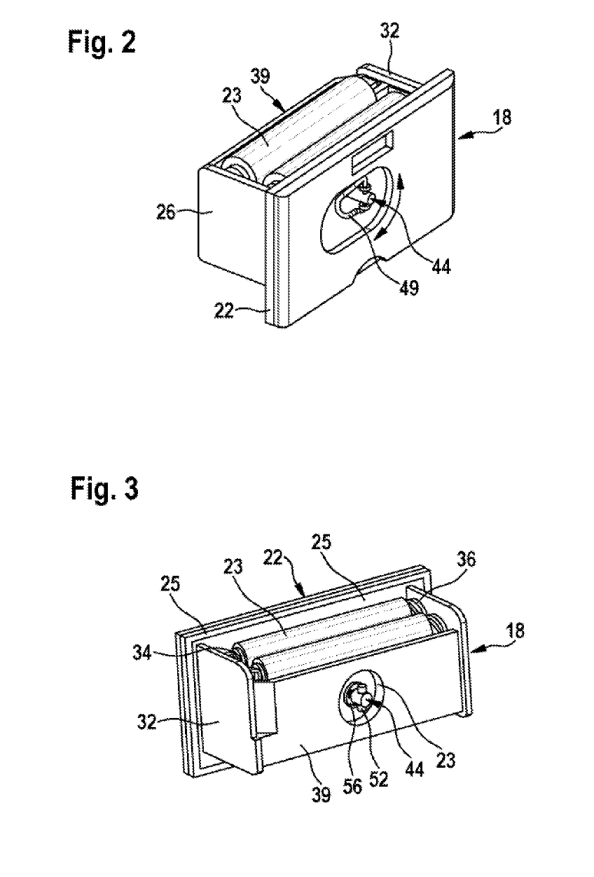

The housing 12 of the distance finder according to the invention has, on its housing lower side facing away from the view in FIG. 1, an insertion opening into which a battery compartment 18 (see FIG. 2) can be inserted. The insertion opening in the housing 12 of the appliance according to the invention is closed off, when the battery compartment is inserted, by a rectangular battery compartment lid, which serves as a cover plate or cover element 22 for the insertion opening of the housing 12.

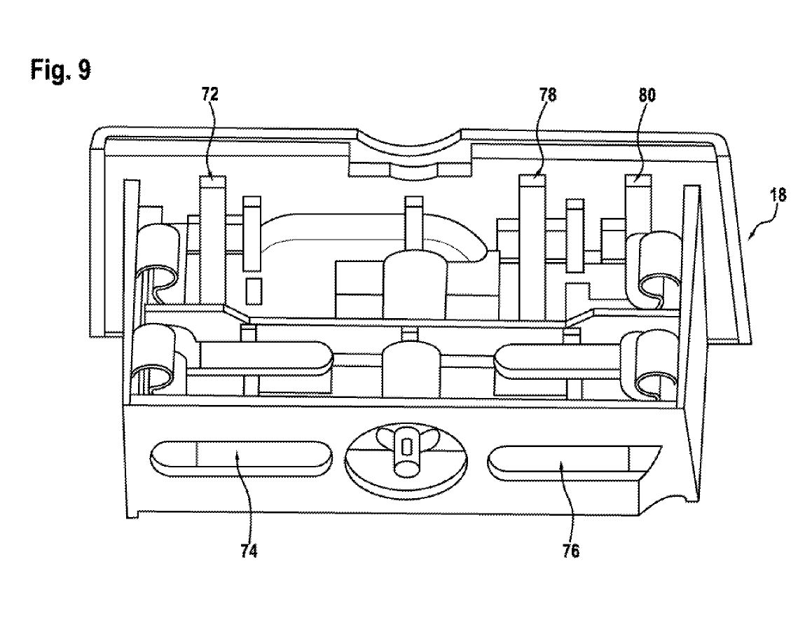

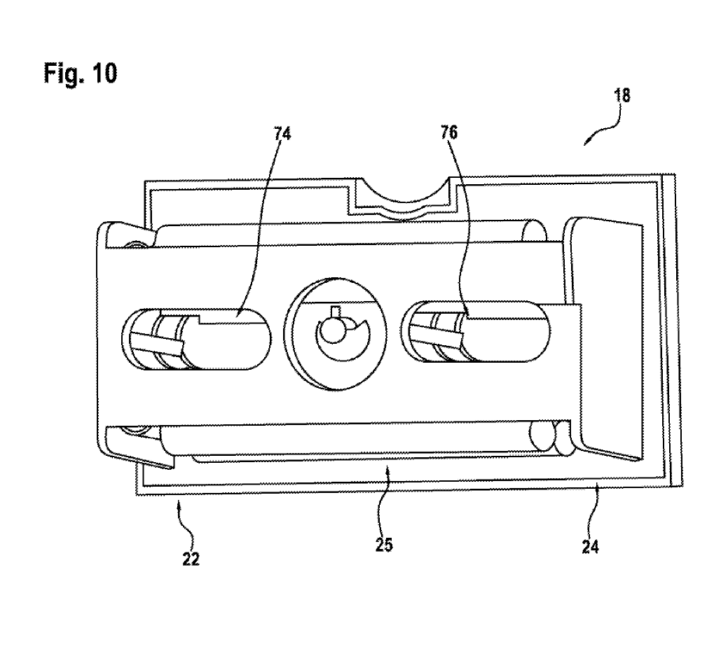

It is expedient and desirable to seal the battery compartment against the ingress of dust and moisture. For this purpose, a sealing element 24 (see, for example, FIG. 9) is provided between the cover element 22 and the insertion opening of the housing 12, which sealing element 24 can be provided as a peripheral sealing element on the edge of the cover element 22 or on the corresponding opposing face of the battery compartment. As is clearly apparent, in particular, in FIG. 9, the cover plate 22 has for this purpose on its outer edge a peripheral seal 24 with which a sealed termination is brought about between the cover plate 22 and the insertion opening of the housing.

It is also possible, as is also described further below, for a sealing ring 54 to be provided between the closure element of the battery compartment, which is advantageously embodied as a closure pin 44 (see in this respect FIG. 5), and the cover element 22. As a result, the ingress of dirt and moisture through the passage hole of the closure element can also be prevented. With these securing measures it is, in particular, possible to configure the electrical appliance according to the IP54 standard despite the removable battery compartment.

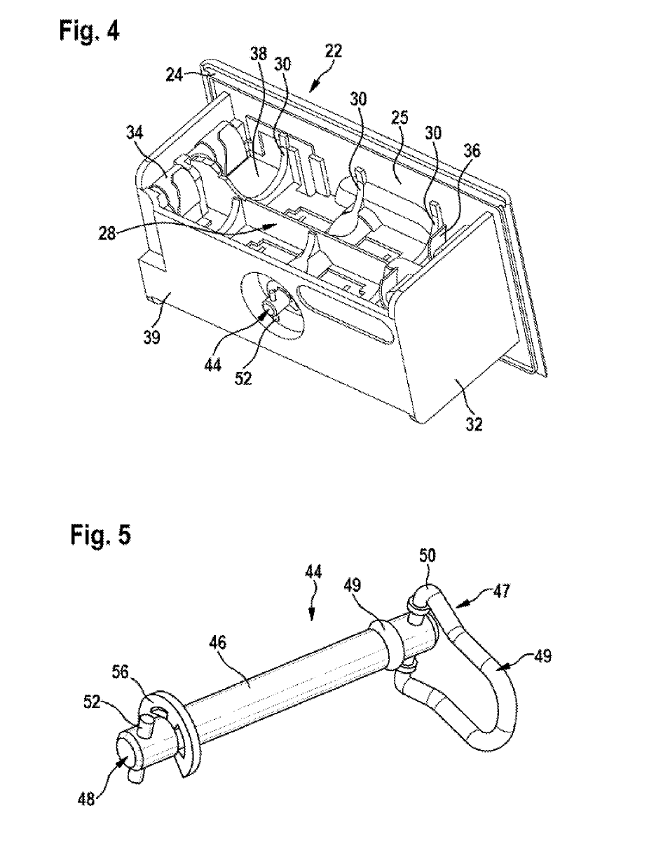

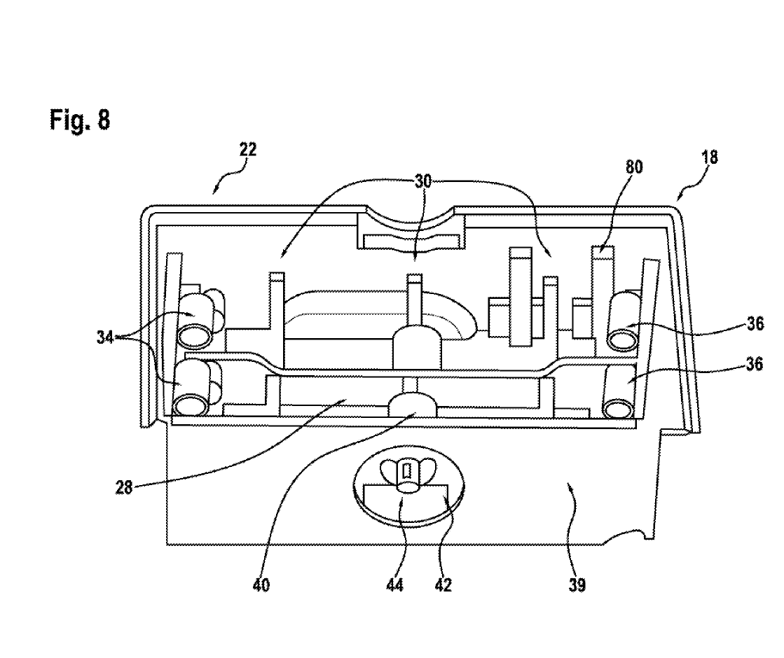

On the inside 25 of the cover element 22, the actual battery holder 26 for accommodating batteries is provided. (See in this respect, for example, FIG. 4 or FIG. 8) The battery holder 26 is embodied in an integral fashion with the cover element 22 and has a central carrier 28 which is removed approximately centrally from the cover element 22 and extends in the transverse direction of the battery compartment lid. On its sides facing one another, the carrier 28 has two sets of three curved fins 30 which form holders for the batteries. Furthermore, the battery holder 26 has end-side securing plates 32 on which electrical contacts 34, 36 for the batteries are secured. These contacts ensure the supply of electrical energy from the battery compartment to the electrical appliance. Finally, the battery holder 26 comprises a rear wall panel 39 which extends between the two end-side securing plates 32, essentially parallel to the cover element acting as a battery compartment lid. End-side securing plates 32, rear wall panel 39, a base plate 38 and cover element 22 therefore form an insert in the form of a drawer which can be inserted into the insertion opening in the housing of the measuring instrument and also removed again therefrom. The battery holder 26 and cover element 22 are manufactured in the exemplary embodiment as a plastic part in a 2-component injection molding method.

In addition, a continuous drilled hole 40 is formed in the battery compartment 18 and axially penetrates the cover element 22 and the battery holder 26 and opens into a recess 42, open toward the upper side of the housing, in the rear wall panel 39 of the battery holder 26. (See in this respect, in particular, FIG. 4 or FIG. 8) A closure element 44 (see FIG. 5) is secured in the continuous drilled hole 40, said closure element axially penetrating the continuous drilled hole 40 and protruding out of this drilled hole with its ends. The closure pin 44 has a rod-shaped or pin-shaped base element 46 which, at the end region 47 which protrudes out of the cover element 22 on the underside of the housing, has a lateral drilled hole in which a wire strut 49 is secured as an activation element 50. At its end region 48 which is located opposite and which emerges from the rear wall panel 39 of the battery holder 26 in the region of the recess 42, the base element 46 has a locking element 52 in the form of a transverse pin which engages through the rod-shaped base element 46. In addition, a sealing ring 54, through which the annular gap which is formed between the base element 46 and the continuous drilled hole 40 is sealed, is secured to the base element 46. In particular, the sealing ring 54 can be secured in an annular groove in the closure pin 44. As a result the sealing ring 54 can firstly be inserted into the annular groove in the closure pin before the latter is introduced into the continuous drilled hole 40 in the battery compartment. The sealing ring is axially positioned in a fixed fashion by the annular groove.

Adjacent to the closure pin 52 a securing element 56 in the form of a disk segment is provided on the rod-shaped base element 46 on the side facing the cover element 22, which base element 46 is positioned in such a way that it comes to bear against the rear wall panel 39 of the battery holder 26, with the result that the closure pin 44 is axially positioned on the battery holder 26. The radial extent of the disk segment of the securing element 56 is advantageously larger than the corresponding extent of the continuous drilled hole 40, with the result that the securing element 56 forms a stop against the battery holder axially on the inside of the locking element 52. As a result, a stop position is formed on the holder of the cover element 22 for the closure pin 44 in the axial direction, with the result that a precisely defined distance of the locking element 52 from the holder is brought about. In this way, the locking element 52 can easily be placed in engagement with the locking region of the housing. The securing element 56 is advantageously embodied here as a disk segment, with the result that it comes to bear essentially flat against the holder. Such an embodiment of the securing element means that the use of standardized parts is advantageously possible.

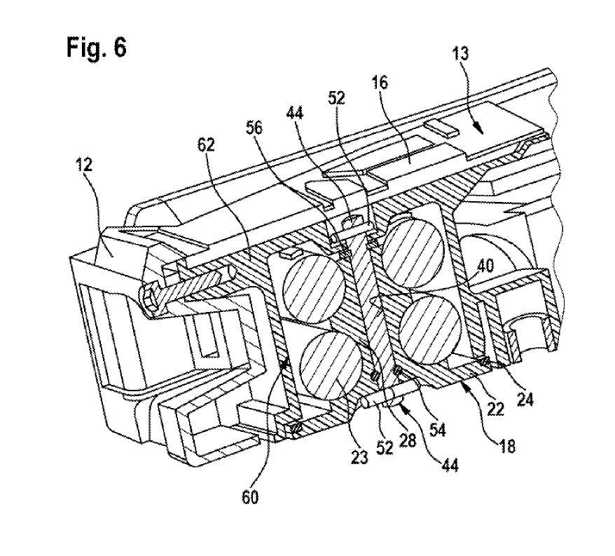

The closure mechanism is once more illustrated in more detail in an illustration of a detail of the figure in FIG. 6.

For this purpose, the appliance housing has, on its inner side in the locking region, a run-up slope with which the locking element comes into engagement in such a way that by rotating the closure pin into a locked position the battery compartment lid is pulled into the battery compartment, as will be explained below in detail.

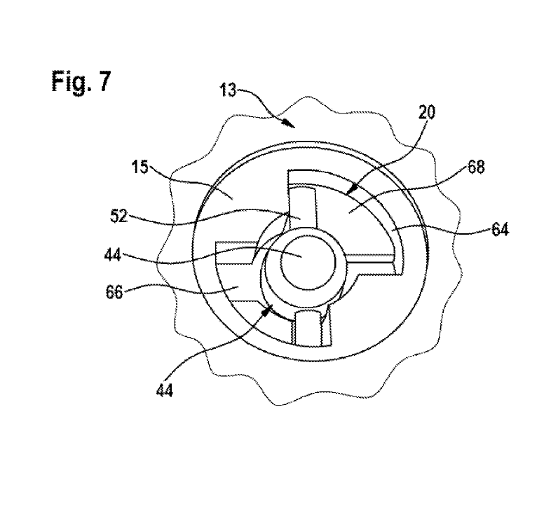

As is apparent, in particular, in FIG. 6, the insertion opening 60 has in the region of its appliance-upper-side inner wall 62 a recess 64 which forms a cavity with respect to the housing upper side 13. In the region of this recess 64 a passage opening 66 is provided (see FIG. 7) which is embodied in such a way that in a predefined position—the open position—the closure pin 44 can be plugged with the locking pin 52 through the passage opening 66, as is shown in FIGS. 1 and 7. Starting from the passage opening 66, a run-up slope 68 is provided on the floor of the recess 66, which run-up slope 68 extends, viewed in the circumferential direction, from the passage opening 66 over an angular range of 90°. The arrangement is implemented in such a way that the locking pin 52 interacts with the run-up slopes 68 in order to pull the battery compartment 18 against the housing 12 of the electrical appliance when the closure pin 44 is rotated out of the open position into a locked position.

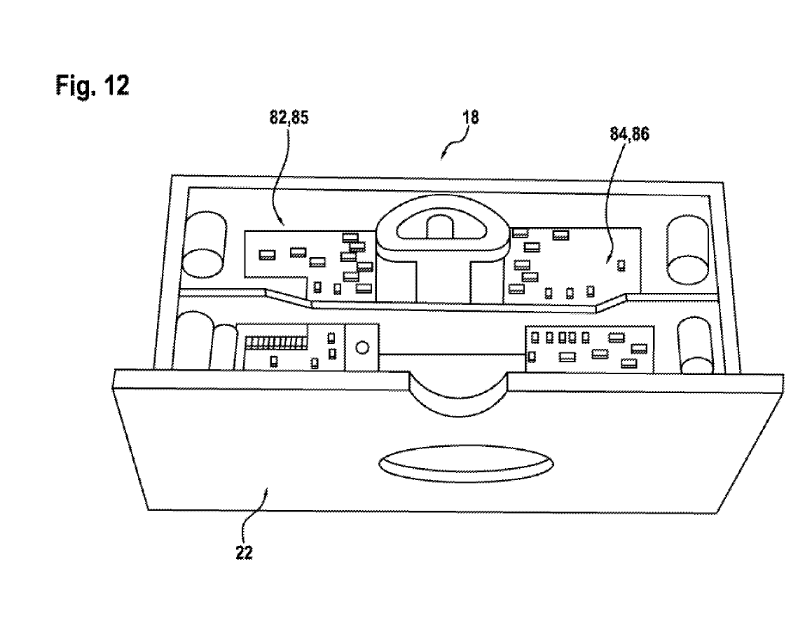

In order to close and secure the battery compartment 18 according to the invention in an electrical appliance, the battery compartment with the communication module arranged therein (see FIG. 11 or 12) is inserted and secured in the insertion opening 60. In this context, the closure pin 44 is moved, by rotation at the wire strut 49, into its open position in which the locking pin 52 can be plugged through the passage 66. In order to lock the battery compartment 18, the closure pin 44 is turned in the counterclockwise direction via the wire strut 49, with the result that the locking element 52 runs over the run-up slope 68 and in the process the battery compartment 18 securely in the housing 12 of the electrical appliance. In this context, the sealing ring 24 of the cover element 22 comes to bear against the wall of the housing 12 and brings about sealed closure of the battery compartment.

In order to exchange the batteries 10 or replace the battery compartment, for example in order to provide the electrical appliance with another communication module, the battery compartment 18 is removed from the housing 12. For this purpose, the closure pin 44 is rotated back through 90° into the open position via the strut 49, with the result that the locking pin 52 can pass through the passage 66, and the battery compartment 18 can be completely removed from the housing 12. The batteries can then simply be removed from the battery holder 26 and replaced with new ones or in a corresponding way a new battery compartment with a possibly changed communication module can be inserted into the appliance again.

Furthermore, the closure pin is stabilized in the holder by means of the guide, with the result that said closure pin can easily be placed in engagement with the locking region of the appliance-side holder since the long guide prevents tilting of the closure pin. The handling is made easier, in particular, if the closure pin is guided centrally through the cover element and the holder. The battery compartment is then pulled steadily into the opening of the housing, as a result of which good sealing of the opening of the housing by the battery compartment is achieved.

Of course, the battery compartment according to the invention can also be secured in the housing of the electrical appliance in other ways. It is possible, for example, to latch in or unlatch the drawer by means of elastically deformable latching elements. For such a system it is appropriate not to insert the drawer of the battery compartment on the rear of the appliance but rather in particular to insert it on the underside 70 (see FIG. 1).

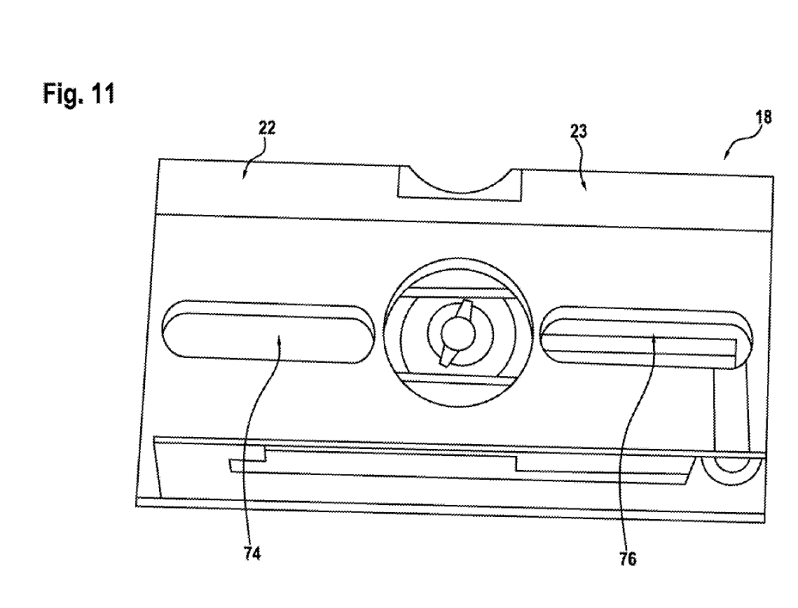

FIG. 9 shows a battery compartment according to the invention with a “single-wire communication pin” 72 as well as two plug-in locations 74, 76 for the communication electronics. The communication pin 72 serves to transmit data between the electronics of the measuring instrument, for example the evaluation unit of the appliance, and the module according to the invention for the external communication. However, in addition to the communication pin 72 shown here it is also in principle possible to allow the data communication to occur via the connections 78, 80 for supplying energy to the appliance. The use of a plurality of communication pins is also possible within the scope of the invention. FIG. 10 shows the modified battery compartment according to the invention without batteries in another perspective in order to clarify the plug-in locations for the external communication. FIG. 11 shows a corresponding view with batteries inserted.

FIG. 12 shows a perspective view of the battery compartment according to the invention with communication electronics inserted. In the present exemplary embodiment, two circuit boards for the communication electronics are situated between the locations for the batteries. The electronics of the communication adapter 85 which processes the data supplied by the measuring instrument via the communication pin 72 and prepares said data for transmission to an external application such as, for example, a computer system, are located on the circuit board (printed circuit board) 83. The communication adapter 85 also ensures that energy is supplied to the communication module. The communication module advantageously obtains its required energy from the energy storage elements located in the battery compartment. The communication adapter can additionally also have a capacitor which functions as an energy buffer and can also ensure reliable data transmission even if the batteries of the system are empty. The actual transmitting unit of the communication interface, for example that is to say a Bluetooth chip or another corresponding interface module, is located on the circuit board 84. The electrical appliance according to the invention can therefore communicate in a cableless fashion and exchange data with a computer or PDA or some other external application. In this context, the communication module according to the invention is not restricted to the transmission of data to an external application. It is equally possible according to the invention to receive data from an external application. It is therefore possible, for example, to input a layout of a building or a building plan or spatial plan of an external computer system into the electrical appliance, for example a distance finder, and to check the distances on the plan with the measuring instrument.

In alternative embodiments, the communication adapter and the transmission module can, in contrast with the embodiment illustrated in FIG. 12, also be integrated on a (printed) circuit board. The priority here is to use the installation space in the battery compartment effectively and to allow for the structural conditions of such a battery compartment. Since the entire communication electronics are located in the IP-protected battery compartment according to the invention, there is advantageously no need for additional measures for protecting the communication electronics.

According to the invention it is therefore possible to extend an electrical appliance, for example a laser distance finder, by adding the function of, in particular, wireless communication and at the same time retain the battery-supported voltage supply and the desired IP protection. The basic appliance, which can accommodate the communication expansion module, is burdened here with additional costs also with other disadvantages.

1. A battery compartment of an electrical appliance, the battery compartment being configured to be reversibly introduced into the electrical appliance and comprising:
at least one holder for an energy storage element;
at least one contact element configured to make electrical contact between the battery compartment and the appliance; and
an interface configured to communicate with an external application.

2. The battery compartment as claimed in claim 1, wherein the interface is configured to communicate wirelessly.

3. The battery compartment as claimed in claim 2, wherein the interface is subject to a communication standard.

4. The battery compartment as claimed in claim 1, further comprising at least one further contact element configured to transmit data between the appliance and the battery compartment.

5. The battery compartment as claimed in claim 1, further comprising at least one electronic unit.

6. The battery compartment as claimed in claim 1, wherein the battery compartment is a drawer with at least one holder and at least one cover element configured as a battery compartment lid.

7. The battery compartment as claimed in claim 6, wherein the at least one cover element has a sealing mechanism on a side facing the at least one holder.

8. The battery compartment as claimed in claim 1, wherein the battery compartment is protected according to the IP54 standard.

9. An electrical appliance comprising:
a battery compartment configured to be reversibly introduced into the electrical appliance, the battery compartment including:
at least one holder for an energy storage element,
at least one contact element configured to make electrical contact between the battery compartment and the appliance, and
an interface configured to communicate with an external application.

10. The electrical appliance as claimed in claim 9, wherein the appliance is a laser distance finder.

11. A system comprising:
at least one electrical appliance; and
at least two battery compartments configured to be reversibly introduced into the electrical appliance, each battery compartment including:
at least one holder for an energy storage element,
at least one contact element configured to make electrical contact between the battery compartment and the appliance, and
an interface configured to communicate with an external application,
wherein the interface of a first battery compartment of the at least two battery compartments is configured to wirelessly communicate with a first communication standard, and the interface the of a second battery compartment of the at least two battery compartments is configured to wirelessly communicate with a second communication standard, and
wherein the first communication standard and the second communication standard are not identical.
